(19) United States
(12) Patent Application Publication
(10) Pub. No.: US 2021/0198535 A1
(43) Pub. Date: Jul. 1, 2021

(54) MULTILAYERED POLYETHERKETONEKETONE ARTICLES AND METHODS THEREOF

(71) Applicant: 3M INNOVATIVE PROPERTIES COMPANY, St. Paul, MN (US)

(72) Inventors: Larry S. Hebert, Hudson, WI (US); Jonathan D. Zook, Stillwater, MN (US); Naiyong Jing, St. Paul, MN (US); Ryan E. Marx, Rosemount, MN (US); Lianzhou Chen, Woodbury, MN (US)

(21) Appl. No.: 16/756,759

(22) PCT Filed: Dec. 20, 2018
(86) PCT No.: PCT/IB2018/060471

§ 371 Date: Apr. 16, 2020

Related U.S. Application Data
(60) Provisional application No. 62/609,749, filed on Dec. 22, 2017.

(51) Int. Cl. C09J 7/50; C09J 7/25; C09J 5/02; B32B 7/12; B32B 27/28

(52) U.S. Cl. CPC C09J 7/50; C09J 7/25; C09J 5/02; B32B 7/12; B32B 27/288; B32B 2307/202; C09J 2481/00; C09J 2477/003; C09J 2471/006; C09J 2463/00; C09J 2433/00; C09J 2483/00

(57) ABSTRACT

Provided are articles, along with related methods, capable of providing an effective adhesive bond to a substrate containing polyetherketoneketone. The multilayered article includes a substrate comprising polyetherketoneketone, an adhesion promoter disposed on the substrate, the adhesion promoter comprising at least one of organotitanate, polyamide, surface-treated nanosilica, ammosilane or epoxy silane, and an adhesive bonded to the adhesion promoter. The adhesive contains at least one of an acrylic polymer, a polysulfide, a polythioether, an epoxy resin, or a silicone resin.

### FIELD OF THE INVENTION

Provided are methods of making multilayered articles containing polyetherketoneketone (PEKK). These multilayered articles can include fiber-reinforced composites and lightning strike films used in aerospace applications.

### BACKGROUND

Manufacturers have turned to composites as replacements for traditional metal materials in various industrial and consumer applications. Advanced composites can have much lower bulk densities than metal, while retaining high strength and rigidity. Fiber reinforced composites have widespread uses in aircraft, wind generators, motor vehicles, sporting goods, furniture, and other applications. The fibers of these composites can be made of carbon, glass, ceramic or aramid, while the resin matrix is generally a polymeric thermosetting material.

In seeking out materials with improved thermal, mechanical, and chemical resistance properties, new thermoplastic materials have gained commercial interest for high performance applications. Thanks to its combination of thermal stability, chemical resistance, toughness and impact strength, PEKK has emerged as a favored resin matrix for parts exposed to demanding environments. These properties can make PEKK especially desirable as a resin matrix material for primary aircraft structures.

Like other composite aircraft structures, parts made from PEKK are electrically insulating and can thus be vulnerable to damage from lightning strikes. On average, lightning strikes a commercial transport aircraft once yearly. Regulations require that aircraft designs meet a threshold of damage requirement to prevent loss or injury from this frequent event.

Lightning strike films can be adhered to the surface of composite aircraft structures to mitigate lightning-related damage. These films create pathways of low electrical resistance throughout the fuselage to move more than 300 coulombs of electrical charge in a single strike from one strike site to the other. Metallic materials can be used on the exterior surfaces of these surfacing films to provide the electrical conductivity. Typical metallic materials include metal woven fabric, random non-woven mat, foil, and perforated metal sheet. These metalized materials can be incorporated into the exterior region of the PEKK based fiber reinforced resin matrix parts with sufficient adhesion to the part and to the paint system.

### SUMMARY

Traditional adhesives, sealers and paints used for bonding to polymers do not generally adhere well to PEKK. Provided herein are articles and methods that capable of providing an effective adhesive bond to PEKK. As a film for lightning protection, these methods have potential applications on primary aircraft structures, aircraft propellers, composite fans, helicopter rotor blades, wind generator blades, and any other fiber reinforced composite part made of epoxy, or PEKK resin.

In a first aspect, a multilayered article is provided. The multilayered article comprises: a substrate comprising polyetherketoneketone; an adhesion promoter disposed on the substrate, the adhesion promoter comprising at least one of organotitanate, polyamide, surface-treated nanosilica, aminosilane, or epoxy silane; and an adhesive bonded to the adhesion promoter, the adhesive comprising at least one of an acrylic polymer, a polysulfide, a polythioether, an epoxy resin, or a silicone resin.

In a second aspect, a method of enhancing bond strength of an adhesive to a polyetherketoneketone-containing substrate is provided, the method comprising: disposing an adhesion promoter onto the polyetherketoneketone-substrate, the adhesion promoter comprising at least one of organotitanate, polyamide, surface-treated nanosilica, aminosilane, or epoxy silane.

In a third aspect, a method of making a lightning strike film is provided, comprising: embedding an electrical conductor in a layer of adhesive; enhancing bond strength of the adhesive to a polyetherketoneketone-containing substrate according to the aforementioned method; and bonding the layer of adhesive to the polyetherketoneketone-containing substrate to obtain the lightning strike film.

In some embodiments, any of the above articles and methods may use substrates containing polyetheretherketone (PEEK) instead of, or in combination with, PEKK.

### BRIEF DESCRIPTION OF THE DRAWINGS

As provided herein:

FIGS. 1 and 2 are side cross-sectional views of multilayered articles according to different exemplary embodiments.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures are not drawn to scale.

### Definitions

As used herein:

“Alkyl” as used herein refers to straight chain, branched, and cyclic chemical groups having from 1 to 40 carbon atoms, 1 to 20 carbon atoms, 1 to 12 carbons or, in some embodiments, from 1 to 8 carbon atoms.

“Alkenyl” refers to straight and branched chain and cyclic alkyl groups as defined herein, except that at least one double bond exists between two carbon atoms.

“Ambient conditions” means at 25° C. and 101.3 kPa pressure.

“Aryl” refers to cyclic aromatic hydrocarbon groups that do not contain heteroatoms in the ring.

“Average” means number average, unless otherwise specified.

“Copolymer” refers to polymers made from repeat units of two or more different polymers and includes random, block and star (e.g. dendritic) copolymers.

“Cure” refers to exposing to radiation in any form, heating, or allowing to undergo a physical or chemical reaction that results in hardening or an increase in viscosity.

“Diameter” refers to the longest dimension of a given object or surface.

“Functional group” refers to a chemical group that can be or is substituted onto a molecule.

“Hydrocarbon” or “hydrocarbyl” refers to a molecule or functional group that includes carbon and hydrogen atoms.

“Organic group” refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups.

“Polymer” refers to a molecule having at least one repeating unit.

“Solvent” refers to a liquid that can dissolve a solid, liquid, or gas.

“Substantially” means to a significant degree, as in an amount of at least 50%, 60, 70, 80, 90, 95, 96, 97, 98, 99, 99.5, 99.9, 99.99, or 99.999%, or 100%.

“Substituted” in conjunction with a molecule or an organic group refers to the state in which one or more hydrogen atoms contained therein are replaced by one or more non-hydrogen atoms.

“Thickness” means the distance between opposing sides of a layer or multilayered article.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

The term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

### Multilayered Articles

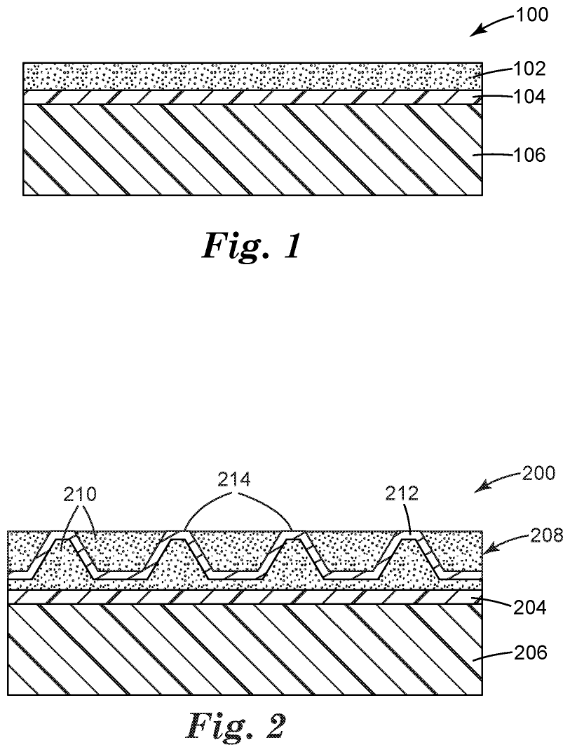

A multilayered article according to one exemplary embodiment is shown in FIG. 1 and herein referred to by the numeral 100. The article 100 has a plurality of discrete layers. These layers are disposed in the following order (from bottom to top): a substrate 106, a layer of adhesion promoter 104 disposed on the substrate 106, and an adhesive layer 102 bonded to the adhesion promoter 104.

The adhesion promoter 104 is a substance that enhances adhesion between the adhesive layer 102 and its underlying substrate 106. An adhesion promoter generally contains a multifunctional chemical compound having a chemical structure with an affinity for the substrate and another chemical structure with an affinity for the adhering species. For some applications, the absence of an adhesion promoter can result in the properties of the applied adhesive being insufficient to meet the performance requirements needed for the end product.

Generally, the adhesion promoter is disposed on the substrate prior to application of the coating, adhesive or sealant. Optionally and as shown, the adhesion promoter 104 and the substrate 106 directly contact each other. Optionally and as shown, the adhesive layer 102 and the adhesion promoter 104 directly contact each other.

The adhesion promoter 104 is interposed between the adhesive layer 102 and the substrate 106. The adhesion promoter 104 may be a continuous layer or alternatively may only extend over only a portion of the substrate 106. Preferably, the adhesion promoter 104 extends over essentially all portions of the substrate 106 covered by the adhesive layer 102.

The adhesion promoter 104 and can include at least one of organotitanate, polyamide, surface-treated nanosilica, aminosilane, or epoxy silane. In some embodiments, it can be desirable for the adhesion promoter to include polymerizable chemical groups. Polymerizable moieties include compounds containing olefinic functionality such as styrenic, vinyl (e.g., vinyltriethoxysilane, vinyltri(2-methoxyethoxy) silane), acrylic and methacrylic moieties (e.g., 3-metacrylroxypropyltrimethoxysilane). Such polymerizable moieties may, in some embodiments, be polymerized by a suitable curing agent present in the adhesive layer or by external stimulus such as electron beam radiation.

Even very small amounts of the adhesion promoter 104 can be highly effective in enhancing adhesion to the substrate 106. In some embodiments, the adhesion promoter is present in a layer having an average thickness of less than 1 nanometer, less than 5 nanometers, less than 10 nanometers, or in some embodiments, less than, equal to, or greater than 1 nanometer, 2, 5, 10, 15, 20, 25, 30, 35, 40, 45, 50, 60, 70, 80, 90, 100, 150, 200, 250, 300, 350, 400, 450, 500, 600, 700, 800, 900, 1000, 1500, 2000, 2500, 3000, 3500, 4000, 4500, of 5000 nanometers.

Alternatively, or in combination, the adhesion promoter can be mixed, or entrained, directly into the adhesive. Where the adhesion promoter is entrained in the adhesive, the adhesion promoter may be present in amount from 0.1 wt % to 15 wt %. In some embodiments, the adhesion promoter may be present in amount less than, equal to, or greater than 0.1 wt %, 0.2, 0.5, 0.7, 1, 1.1, 1.2, 1.5, 1.7, 2, 2.5, 3, 3.5, 4. 4.5, 5, 5.5, 6, 6.5, 7, 7.5, 8, 8.5, 9, 9.5, 10, 11, 12, 13, 14, or 15 wt %, based on the total weight of the adhesive. The entrained adhesion promoter may have the same composition as, or have common components with, the adhesion promoter 104.

Adhesion promoters entrained in the composition can contain a mercaptan, amino, and/or epoxy silane functional group. Advantageously, such adhesion promoters can have a molecular weight providing for mobility of the compound within the composition. An adhesion promoter containing a mercaptan, amino, and/or epoxy silane functional group can have an equivalent weight of less than 5000 g/mol, less than 3000 g/mol, less than 1000 g/mol, or in some embodiments, less than, equal to, or greater than 5000 g/mol, 4750, 4500, 4250, 4000, 3750, 3500, 3250, 3000, 2750, 2500, 2250, 2000, 1750, 1500, 1250, 1000, 750, or 500 g/mol.

The adhesive layer 102 may be comprised of an acrylic polymer, polysulfide, a polythioether, an epoxy resin, or a silicone resin. In some embodiments, the adhesive of the adhesive layer 102 is a thermoset adhesive. In some embodiments, the adhesive of the adhesive layer 102 is pressure sensitive adhesive.

The adhesive layer 102 can have any thickness sufficient to provide acceptable adhesion between to the substrate 106. If two substrates are being bonded to each other, amount of adhesive should be adequate to cover opposing bonding surfaces. The thickness of the adhesive layer 102 can be from 8 micrometers to 450 micrometers, from 12 micrometers to 250 micrometers, from 15 micrometers to 100 micrometers, or in some embodiments, less than, equal to, or greater than 8 micrometers, 9, 10, 11, 12, 13, 14, 15, 17, 20, 22, 25, 30, 35, 40, 45, 50, 60, 70, 80, 90, 100, 120, 150, 170, 200, 220, 250, 270, 300, 320, 350, 370, 400, 420, or 450 micrometers.

FIG. 2 shows a multilayered article 200 according to another exemplary embodiment. The article 200, like the previously described article 100, includes a substrate 206 and an adhesion promoter 204 disposed on the substrate 206.

Unlike the prior article 100, the article 200 includes a surfacing film 208 that is disposed on adhesion promoter 204. The surfacing film 208 has an exposed major surface that also represents a major surface of the article 200. As shown, the surfacing film 208 is a composite film that includes an adhesive 210 and an electrical conductor 212 embedded in the adhesive 210. Here, the electrical conductor 212 is a continuous electrically conductive film shaped to have a two-dimensional array of protruding features 214.

The electrical conductor 212 can have any suitable thickness to conduct electricity away from the site of a lightning strike. In some embodiments, the thickness is in the range of from 0.001 micrometers to 100 micrometers, from 0.005 micrometers to 500 micrometers, or from 0.01 and 10 microns. In some embodiments, the electrical conductor 212 has a basis weight of up to 50 g/m².

The electrical conductor 212 is not limited to continuous films. Other electrical conductors can include, for example, metallized woven fabric, metalized paper, foraminous (i.e., porous) metal films or foils, metal wires, metal mesh, metal particles, carbon particles or carbon fibers. Foraminous metal foils can include expanded metal foils, which are slitted along one direction and then stretched along a traverse direction to obtain porous conductive films.

Other aspects of the article 200 are analogous to those of the multilayer article 100 and thus need not be repeated.

The provided articles 100,200 may include one or more additional layers disposed on the exposed major surface of the adhesive layer 102, 210 (facing away from the adhesion promoter 104, 204 and substrate 106, 206). Such additional layers can include backings that can impart strength, enhanced chemical resistance, and/or a desirable surface texture. Useful backing materials include, for example, fluoropolymers such as polyvinylidene fluoride. Alternatively, or in combination, additional layers can include ionizable paint layers for aesthetic reasons. Such layers are omitted from these drawings here for the sake of clarity.

Further details concerning the substrate, adhesion promoter, and adhesive layers are provided in respective subsections below.

### Substrates

The substrate 106, 206 on which the adhesion promoter 104, 204 is disposed contains PEKK. “PEKK” refers to a polyetheretherketone polymer comprising, and preferably consisting of, repeat units having the structure I below:

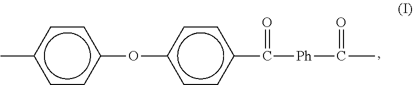

where Ph represents a 1,4-phenylene group (in which case the —CO-Ph-CO— unit denotes a terephthalyl group) and/or monomers of formula (I) where Ph represents a 1-3-phenylene group (in which case the —CO-Ph-CO— unit denotes an isophthalyl group). One or both phenyl groups may optionally be substituted with C1 to C8 alkyl groups.

PEKK has demonstrated an excellent balance of properties, including a glass transition temperature of from 155° C. to 160° C., a maximum service temperature of up to 250° C., high tensile strength (approximately 90 MPa), high stiffness (higher than 3.4 GPa), low moisture absorption (less than 0.2 wt %) and a moderate processing temperature (330-380° C.). Embedding reinforcing fibers in a PEKK resin matrix can result in a fiber-reinforced composite having the high stiffness and strength for aerospace applications.

PEKK materials are available from any of a number of manufacturers, such as RTP Company, Winona, Minn.

PEKK can represent any suitable portion of a given substrate. The substrate may include PEKK homogeneously or heterogeneously mixed with other components. In some embodiments, PEKK represents less than, equal to, or greater than 50 wt %, 55, 60, 65, 70, 75, 80, 85, 90, 95, 96, 97, 98, 99, or 100 wt % of the substrate, relative to the overall weight of the substrate.

### Adhesion Promoters

An adhesion promoter 104, 204 containing at least one of organotitanate, polyamide, surface-treated nanosilica, aminosilane, or epoxy silane was found to provide a surprisingly high bond strength between the substrate and adhesive compared to the bond strength without the adhesion promoter 104, 204. In some embodiments, the adhesion promoter 104, 204 can provide an increase in peel adhesion strength of from 10% to 5000%, from 30% to 2000%, from 50% to 1000%, or in some embodiments, less than, equal to, or greater than 10%, 20, 30, 40, 50, 60, 70, 80, 90, 100, 110, 120, 150, 170, 200, 300, 400, 500, 600, 700, 800, 900, 1000, 1200, 1500, 2000, 3000, 4000, or 5000%, based on the 180° Peel Adhesion Test (see Examples).

Useful adhesive promoters are described as follows.

### Organotitanates

In some embodiments, the adhesion promoter contains organotitanate. In a preferred embodiment, the adhesion promoter is comprised of organotitanate and the adhesive is comprised of a polysulfide or polythioether.

Organotitanates are characterized by Ti—O—C linkages, and include alkoxytitanium esters, titanium chelates and titanium acylates. Organotitanates can be made from titanium tetrachloride, TiCl₄, which can be converted to tetraisopropyl titanate, then converted by alkoxy exchange (transesterification) to a wide variety of tetraalkyl titanates. The tetraalkyl titanates react with other ligands and chelating agents, such as glycols, β-diketones and ketoesters, α-hydroxycarboxylic acids, and alkanolamines.

Organotitanates include, but are not limited to, titanium tetramethoxide, titanium tetraethoxide, titanium tetra-allyloxide, titanium tetra-n-propoxide, titanium tetra-isopropoxide, titanium tetra-n-butoxide, titanium tetra-isobutoxide, titanium tetra-s-butoxide, titanium tetra-tert-butoxide, titanium tetra-n-pentoxide, titanium tetra-cyclopentyloxide, titanium tetra-n-hexyloxide, titanium tetra-cyclohexyloxide, titanium tetra-benzyloxide, titanium tetra-n-octyloxide, titanium tetra-2-ethylhexyloxide, titanium tetra-nonyloxide, titanium tetra-n-decyloxide, titanium tetra-isooctyloxide, titanium tetra-isobornyloxide, titanium tetra-benzhydryloxide, titanium tetra-oleyloxide, titanium tetra-phenoxide, titanium tetra-o-chlorophenoxide, titanium tetra-p-chlorophenoxide, titanium tetra-o-nitrophenoxide, titanium tetra-p-nitrophenoxide, titanium tetra-o-methylphenoxide, titanium tetra-m-methylphenoxide, titanium tetra-1-naphthyloxide, titanium tetra-2-naphthyloxide, titanium tetra-resorcinyloxide, titanium tetra-stearyloxide, titanium tetra-2,4,6-trinitrophenoxide, and mixtures thereof.

Additional detail concerning titanate coupling agents can be found in Monte, S. J., Kenrich Petrochemicals, Inc., “Ken-React® Reference Manual—Titanate, Zirconate and Aluminate Coupling Agents”, Third Revised Edition, March, 1995.

### Polyamides

In some embodiments, the adhesion promoter contains a polyamide. In a preferred embodiment, the adhesion promoter is comprised of polyamide and the adhesive is comprised of an acrylic polymer.

A polyamide is a polymer containing repeat units linked by amide bonds, which have the following structure II below:

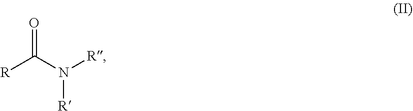

where each of R, R′, and R″ independently refer to a hydrogen or an organic group.

Types of polyamides include aliphatic polyamides, polyphthalamides, and aramids. Polyamides are made by polymerization of monomers containing different chemical groups to form an amide linkage. Generally, the two groups involved are an amine group, and a terminal carbonyl component of a functional group. These can react with each other to produce a carbon-nitrogen bond of a singular amide linkage. The carbonyl-component may be part of either a carboxylic acid group or the more reactive acyl halide derivative. The amine group and the carboxylic acid group can be on the same monomer, or the polymer can be constituted of two different bifunctional monomers, one with two amine groups, the other with two carboxylic acid or acid chloride groups.

Certain polyamides, such as nylons, can be made using a condensation reaction. Nylons are polyamides based on a straight chain (aliphatic) monomer. The hydroxyl from the carboxylic acid combines with a hydrogen from the amine, and produces water as an elimination byproduct. Other polyamides, such as polyamide 6, can be made by a ring-opening polymerization.

Specific examples of polyamides include polyamide 6; polyamide 6,6; polyamide 6,10; polyamide 11; and polyamide 12.

### Surface-Treated Nanoparticles

In some embodiments, the adhesion promoter contains surface-treated nanoparticles. In a preferred embodiment, the adhesion promoter is comprised of surface-treated nanosilica and the adhesive is comprised of a silicone resin.

Useful surface-treated nanoparticles include surface-treated silica nanoparticles. Silica nanoparticles can be colloidal and substantially spherical in shape. Other colloidal metal oxides, e.g., colloidal titania, colloidal alumina, colloidal zirconia, colloidal vanadia, colloidal chromia, colloidal iron oxide, colloidal antimony oxide, colloidal tin oxide, and mixtures thereof, can also be used as an adhesion promoter. Surface-treated nanoparticles can also include surface-treated nanocalcite, such as described in U.S. Pat. No. 9,221,970 (Schultz et al) and U.S. Pat. No. 9,512,264 (Condo et al.) and U.S. Patent Publication No. 2012/0244338 (Schultz et al.).

Surface-treated nanoparticles can be comprised of essentially a single oxide such as silica or can comprise a core of an oxide of one type (or a core of a material other than a metal oxide) on which is deposited an oxide of another type. The median diameter of the nanoparticles can be from 100 nanometers to 500 nanometers, from 20 nanometers to 100 nanometers, from 5 nanometers to 20 nanometers, or in some embodiments, less than, equal to, or greater than 1 nanometer, 2, 5, 7, 10, 15, 20, 25, 30, 35, 40, 45, 50, 60, 70, 80, 90, 100, 150, 200, 250, 300, 350, 400, 450, 500, 600, 700, 800, 900, or 1000 nanometers.

The colloidal nanoparticles can be relatively uniform in size and remain substantially non-aggregated. Nanoparticle aggregation can result in precipitation, gelation, or undesirable increases in viscosity, so it can be preferable to avoid aggregation by using sols of inorganic nanoparticles (e.g., colloidal dispersions of inorganic nanosilica particles in liquid media). Sols can be prepared by a variety of techniques and in a variety of forms which include hydrosols (where water serves as the liquid medium), organosols (where organic liquids are used), and mixed sols (where the liquid medium comprises both water and an organic liquid). Descriptions of these are given in U.S. Pat. No. 2,801,185 (Her) and U.S. Pat. No. 4,522,958 (Das et al.), as well as those given by R. K. Her in The Chemistry of Silica, John Wiley & Sons, New York (1979), which descriptions are incorporated herein by reference.

Preparation of the sol generally requires that at least a portion of the surface of the inorganic nanosilica particles is modified to aid in the dispersibility of the nanosilica particles. This surface modification can be effected by various different methods which are known in the art. Exemplary surface modification techniques are described in U.S. Pat. No. 2,801,185 (Her) and U.S. Pat. No. 4,522,958 (Das et al.), whose descriptions are incorporated herein by reference.

Silica nanoparticles can be treated with monohydric alcohols, polyols, or mixtures thereof (preferably, a saturated primary alcohol) under conditions such that silanol groups on the surface of the particles chemically bond with hydroxyl groups to produce surface-bonded ester groups. The surface of silica (or other metal oxide) particles can also be treated with organosilanes, e.g, alkyl chlorosilanes, trialkoxy arylsilanes, or trialkoxy alkylsilanes, or with other chemical compounds, e.g., organotitanates, which are capable of attaching to the surface of the particles by a chemical bond (covalent or ionic) or by a strong physical bond, and which are chemically compatible with the dispersing medium.

If the adhesion promoter is to be used with an aromatic ring-containing epoxy resin, then it can be beneficial to use surface treatment agents that also contain at least one aromatic ring for improved compatibility with the adhesive.

A hydrosol (e.g., a nanosilica dispersion in water) can generally be combined with a water-miscible organic liquid (e.g., an alcohol, ether, amide, ketone, or nitrile). Alcohol and/or the surface treatment agent can generally be used in an amount such that at least a portion of the surface of the nanoparticles is modified sufficiently to enable the formation of a stable sol. Preferably, the amount of alcohol and/or treatment agent is selected to provide particles which are at least 50 wt %, at least 55 wt %, at least 60 wt %, at least 65 wt %, or at least 70 wt % metal oxide.

Alcohol can be added in an amount sufficient for the alcohol to serve as both diluent and treatment agent. The resulting mixture can then be heated to remove water by distillation or by azeotropic distillation and can then be maintained at a temperature of, e.g., 100° C. for a period of, e.g., 24 hours to enable the reaction (or other interaction) of the alcohol and/or other surface treatment agent with chemical groups on the surface of the nanoparticles. This provides a sol comprising nanoparticles which have surface-attached or surface-bonded organic groups (“substantially inorganic” nanoparticles).

### Organosilanes

In some embodiments, the adhesion promoter contains an organosilane, which is an organometallic compound containing a carbon-silicon bond. Examples of organosilanes include aminosilanes, epoxy silanes, and mercaptosilanes. Examples of mercaptosilanes used as adhesion promoters include gamma-me rcaptopropyltrimethoxysilane, gamma-mercaptopropyltriethoxysilane, gamma-mercaptopropylmethyldimethoxysilane, gamma-mercaptopropylmethyldiethoxysilane, mercaptomethyltrimethoxysilane, mercaptomethyltriethoxysilane, and combinations thereof.

In some embodiments, the adhesion promoter contains an aminosilane. In a preferred embodiment, the adhesion promoter is comprised of aminosilane and the adhesive is comprised of a silicone resin.

Aminosilanes are a species of organosilanes that contains one or more silicon-carbon bonds along with a primary or secondary amine. Aminosilanes can be an effective surface modifier for promoting adhesion of certain adhesives to PEKK. Exemplary aminosilanes include α-aminoethyltriethoxysilane, γ-aminopropyltriethoxysilane, α-aminopropyltriethoxysilane, γ-aminopropyltriethoxysilane, α-aminobutyltriethoxysilane, and N-β-(aminoethyl)-γ-aminopropyltrimethoxysilane.

The aminosilane compound is incorporated in an amount of 0.1 to 5 parts by weight, preferably 0.3 to 3 parts by weight, per 100 parts by weight of the total polymer component (the sum of the polyamide resin and the modified polyolefin or the like).

In some embodiments, the adhesion promoter contains an epoxy silane. In a preferred embodiment, the adhesion promoter is comprised of an epoxy silane and the adhesive is comprised of an epoxy resin. Epoxy silanes can also be used as adhesion promoter for adhesives based on urethanes and acrylic polymers.

Epoxy silanes contain a containing a carbon-silicon bond covalently bonded to a 3-member cyclic ether (i.e., epoxide group). Advantageously, the epoxide group can be made reactive with many organic functionalities. Further, the silane functionality of an epoxy silane can enable bonding to inorganic materials under either wet or dry conditions.

Useful epoxy silanes include Dow Corning Z-6040 Silane (3-glycidoxypropyl trimethoxysilane) available from Dow Corning Corporation, Midland, Mich., and adhesion promoters commercially available from Momentive Performance Materials, Inc., Waterford, N.Y., under the trade designations “SILQUEST A-187” and “SILQUEST A-1100”.

The silane is generally provided as a solution prepared by adding silane to a mixture of a solvent, for example, isopropanol and water, at ambient temperature. The weight ratio of the solvent/water can range from 50/50 to 99.5/0.5. The silane solution can contain from 0.1 wt % to 1 wt % of silane based on total weight of the silane solution. The silane solution can contain from 0.3 wt % to 0.7 wt % of silane, relative to the total weight of the silane solution. Additional details concerning epoxy silanes can be found in U.S. Patent Publication No. 2005/0081993 (Ikkaa et al.).

Adhesion promoters need not be limited to those specifically enumerated above. Other useful adhesion promoters include, for example, phenolics, such as a phenolic resin available under the trade designation “METHYLON.” Other useful adhesion promoters include organozirconates, which can be used in applications where organotitanates could be used.

### Adhesives

The provided articles and methods use a discrete adhesive layer 102, 210, such as shown FIGS. 1 and 2. As used herein, the term “adhesive” is broadly construed as a substance capable of being directly adhered to one or more substrates. Adhesives may be used to adhere two substrates to each other or adhered only to a single substrate. Adhesives may include pressure-sensitive adhesives, curable adhesives, structural adhesives, sealants, primers, and other coatings.

Types of adhesives compatible with the disclosed adhesion promoters are further described in the subsections below.

### Acrylic Polymers

In some embodiments, the adhesive is based on an acrylic polymer. Adhesives containing acrylic polymers include adhesive films and adhesive foams. Useful adhesive films or adhesive foams include pressure-sensitive adhesives that are at least partially cured prior to being applied onto the adhesion promoter and/or substrate.

Exemplary acrylic adhesives can be prepared by reacting an acid-functional (meth)acrylate copolymer and a crosslinking system comprising a crosslinking agent and epoxy-functional (meth)acryloyl monomer, which when crosslinked, provides a pressure-sensitive adhesive.

The (meth)acrylate ester monomers useful in preparing the acid functional (meth)acrylate adhesive copolymer can be monomeric (meth)acrylic ester of a non-tertiary alcohol, which alcohol contains from 1 to 14 carbon atoms and preferably an average of from 4 to 12 carbon atoms.

Examples of monomers suitable for use as the (meth)acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. In some embodiments, the preferred (meth)acrylate ester monomer is the ester of a (meth)acrylic acid with butyl alcohol or isooctyl alcohol, or a combination thereof, although combinations of two or more different (meth)acrylate ester monomer are suitable. In some embodiments, the preferred (meth)acrylate ester monomer is the ester of (meth)acrylic acid with an alcohol derived from a renewable sources, such as 2-octanol, citronellol, and dihydrocitronellol.

In some embodiments, it is desirable for the (meth)acrylic acid ester monomer to include a monomer having a glass transition temperature of at least 25° C., and preferably at least 50° C. Suitable high glass transition temperature monomers include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, propyl methacrylate, and combinations thereof.

The (meth)acrylate ester monomer can be present in an amount of 85 to 99.5 parts by weight based on 100 parts total monomer content used to prepare the polymer. Preferably (meth)acrylate ester monomer is present in an amount of 90 to 95 parts by weight based on 100 parts total monomer content. When high glass transition temperature monomers are included, the copolymer may include up to 30 parts by weight, preferably up to 20 parts by weight of the 85 to 99.5 parts by weight of (meth)acrylate ester monomer component.

Further details concerning acrylic-based adhesives are described in U.S. Pat. No. 8,148,471 (Kavanagh et al.).

### Polysulfides and Polythioethers

In some embodiments, the adhesive contains a polysulfide, polythioether, or copolymer thereof. The adhesive can be a curable adhesive that is cured by mixing a first component and second component with each other. The first and second components can be provided by the manufacturer separately for in situ mixing and curing by the user. Alternatively, the adhesive may be provided fully cured, in which the first and second components have already been mixed to any suitable degree, such as substantially homogeneously mixed.

In a two-part composition, the first component can include a liquid that is a polysulfide, a polythioether, a copolymer thereof, or a combination thereof. The second component can include one or more glycol di((C₁-C₂₀) hydrocarbyl) carboxylate esters, wherein at each occurrence the (C₁-C₂₀)hydrocarbyl is independently substituted or unsubstituted. The second component can also include an oxidizing agent. Any material in the adhesive described herein as being part of the first component can alternatively be employed in part or in whole in the second component or in another component of the adhesive, and likewise any material described herein as being part of the second component can alternatively be employed in part or in whole in the first component or in another component of the adhesive.

The weight ratio of the first component to the second component can be any suitable ratio, such as 2:1 to 14:1, or 9:1 to 11:1, or 2:1 or less, or less than, equal to, or greater than 3:1, 4:1, 5:1, 6:1, 7:1, 8:1, 9:1, 9.5:1, 10:1, 10.5:1, 11:1, 12:1, 13:1, or 14:1 or more. The first component can be any suitable proportion of the adhesive. The first component can be 80 wt % to 95 wt % of the adhesive, 90 wt % to 93 wt %, 80 wt % or less, or less than, equal to, or greater than 81 wt %, 82, 83, 84, 85, 86, 87, 88, 89, 90, 90.5, 91, 91.5, 92, 92.5, 93, 94 wt %, or 95 wt % or more. The second component can be any suitable proportion of the adhesive, such as 5 wt % to 20 wt % of the adhesive, or 7 wt % to 10 wt % of the adhesive, or 5 wt % or less, or less than, equal to, or greater than 6 wt %, 7, 8, 9, 10, 11, 12, 14, 16, 18, or 20 wt % or more.

One-part compositions are also possible, in which the polysulfide, polythioether, or copolymer thereof is cured by actinic radiation. For example, a polythioether polymer network can be obtained by radiation curing a composition that includes: a) at least one dithiol monomer; b) at least one diene monomer; c) at least one multifunctional monomer having at least three ethenyl groups; and d) at least one photoinitiator. As another example, a polythioether polymer network can be radiation-cured from a dual-cure composition including: a) a dithiol monomer; b) a diene monomer; c) a radical cleaved photoinitiator; d) a peroxide; and e) an amine; where the peroxide and amine together are a peroxide-amine redox initiator.

Further details concerning radiation-cured polysulfides, polythioethers, and copolymers thereof are described in U.S. Pat. No. 9,650,150 (Zook et al.), U.S. Patent Publication No. 2016/0032058 (Ye et al.) and International Patent Publication No. WO 2016/106352 (Ye et al).

Examples of polysulfides, polythioethers, and copolymers thereof include polymers including repeating units that include a sulfide (e.g., —S—S—) or a thioether (e.g., -thio(C₁-C₅)alkylene)-) moiety therein, and including pendant or terminal mercaptan (i.e., —SH) groups. Examples of polysulfides can include polymers formed by condensing bis(2-chloroethoxy)methane with sodium disulfide or sodium polysulfide. Examples of polythioethers include polymers formed via condensation reaction of, for example, 2-hydroxyalkyl sulfide monomers such as those described in U.S. Pat. No. 4,366,307 (Singh et al.) and those formed via addition reactions of dithiols and divinylethers such as those described in U.S. Pat. No. 6,486,297 (Zook et al).

The polysulfide, polythioether, or copolymer thereof can have any suitable molecular weight, such as a number-average molecular weight of 500 g/mol to 5,000 g/mol, or 500 g/mol to 1,500 g/mol, or 500 g/mol or less, or less than, equal to, or greater than 600 g/mol, 700, 800, 900, 1,000, 1,100, 1,200, 1,300, 1,400, 1,500, 1,600, 1,800, 2,000, 2,250, 2,500, 2,750, 3,000, 3,500, 4,000, 4,500, or 5,000 g/mol or more.

The polysulfide, polythioether, copolymer thereof, or mixture thereof can have any suitable mercaptan content based on the overall weight of the liquid polysulfide, such as 0.1 wt % to 20 wt %, 1 wt % to 10 wt %, 1 wt % to 6 wt %, or 1 wt % to 3 wt %, or 0.1 wt % or less, or less than, equal to, or greater than 0.5 wt %, 1, 3, 4, 5, 6, 7, 8, 9, 10, 12, 14, 16, 18, or 20 wt % or more.

The polysulfide, polythioether, or copolymer thereof, or mixture thereof can form any suitable proportion of the first component, such as 40 wt % to 100 wt % of the first component, 50 wt % to 80 wt %, or 40 wt % or less, or less than, equal to, or greater than 45 wt %, 50, 55, 60, 65, 70, 75, 80, 85, 86, 88, 90, 91, 92, 93, 94, 95, 96, 97, 98, 99, 99.9 wt %, or 99.99 wt % or more.

The polysulfide, polythioether, copolymer thereof, or mixture thereof can form any suitable proportion of the adhesive, such as 30 wt % to 95 wt % of the adhesive, or 40 wt % to 70 wt %, or 40 wt % or less, or less than, equal to, or greater than 45 wt %, 50, 55, 60, 65, 70, 72, 74, 76, 78, 80, 81, 82, 83, 84, 85, 86, 87, 88, 89, 90, 91, 92, 93, 94, or 95 wt % or more.

### Epoxys

Useful adhesives can include one or more monomers or polymers based on an epoxy (i.e., an epoxy resin). Epoxy resins are characterized by the presence of an epoxide group. The epoxy resin may contain more than one epoxide group, in which case it is referred to as a polyepoxide. Epoxy resins may be saturated or unsaturated, aliphatic, alicyclic, aromatic, or heterocyclic, or any combination thereof. The epoxy resins can be made curable, or hardenable, by the addition of a curing agent. Known curing agents include anhydrides, amines, polyamides, Lewis acids, and salts.

Aromatic polyepoxides, known for their high temperature performance, are compounds having at least one aromatic ring structure, e.g. a benzene ring, and more than one epoxy group. Useful aromatic polyepoxides can contain at least one aromatic ring (e.g., phenyl group) that is optionally substituted by a halogen, alkyl having 1 to 4 carbon atoms (e.g., methyl or ethyl), or hydroxyalkyl having 1 to 4 carbon atoms (e.g., hydroxymethyl). The aromatic polyepoxide can contain at least two or more aromatic rings and in some embodiments, can contain 1 to 4 aromatic rings. For polyepoxides and epoxy resin repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, the aromatic polyepoxide or epoxy resin is an epoxy novolac. In these embodiments, the novolac epoxy may be a phenol novolac, an ortho-, meta-, or para-cresol novolac, or a combination thereof. In some embodiments, the aromatic polyepoxide or epoxy resin is a bisphenol diglycidyl ether, wherein the bisphenol (i.e., —O—C₆H₅—CH₂—C₆H₅—O—) may be unsubstituted, or either of the phenyl rings or the methylene group may be substituted by halogen (e.g., fluoro, chloro, bromo, iodo), methyl, trifluoromethyl, or hydroxymethyl. In some embodiments, the polyepoxide is a novolac epoxy resin (e.g., phenol novolacs, ortho-, meta-, or para-cresol novolacs or combinations thereof), a bisphenol epoxy resin (e.g., bisphenol A, bisphenol E, bisphenol F, halogenated bisphenol epoxies, fluorene epoxies, and combinations thereof), a resorcinol epoxy resin, and combinations of any of these. Examples of useful aromatic monomeric polyepoxides include the diglycidyl ethers of bisphenol A and bisphenol F and tetrakis glycidyl-4-phenylolethane and combinations thereof.

Useful aromatic polyepoxides also include polyglycidyl ethers of polyhydric phenols, glycidyl esters of aromatic carboxylic acid, N-glycidylaminobenzenes, and glycidylamino-glyclidyloxy-benzenes. The aromatic polyepoxides can be the polyglycidyl ethers of polyhydric phenols.

Examples of aromatic polyepoxides include the polyglycidyl derivatives of polyhydric phenols such as 2,2-bis-[4-(2,3-epoxypropoxy)phenyl]propane and those described in U.S. Pat. No. 3,018,262 (Schroeder) and U.S. Pat. No. 3,298,998 (Coover et al.), and in “Handbook of Epoxy Resins” by Lee and Neville, McGraw-Hill Book Co., New York (1967). Useful polyglycidyl ethers of polyhydric phenols include diglycidyl ethers of bisphenol that have pendent carbocyclic groups. Examples of useful diglycidyl ethers are 2,2-bis[4-(2,3-epoxypropoxy)phenyl]norcamphane and 2,2-bis[4-(2,3-epoxypropoxy)phenyl]decahydro-1,4,5,8-dimethanonaphthalene. One preferred diglycidyl ether is 9,9-bis[4-(2,3-epoxypropoxy)phenyl]fluorene.

The polyepoxide can be any suitable weight fraction of the adhesive, such as 10 wt % to 99 wt %, 15 wt % to 95 wt %, 25 wt % to 90 wt %, or in some embodiments less than, equal to, or greater than 10 wt %, 12, 15, 20, 25, 30, 35, 40, 45, 50, 55, 60, 65, 70, 75, 80, 85, 90, 95, 96, 97, 98, or 99 wt %, relative to the overall weight of the adhesive.

The epoxy resins can include at least one curing agent. Some curing agents provide an epoxy-based adhesive that is thermally curable. A thermally curable adhesive does not cure at room temperature but cures at elevated temperatures. Epoxy resins may also be curable by actinic radiation, such as by exposure to ultraviolet or visible light.

Common curing agents for epoxies include amines, such as aliphatic amines, amidoamines, cycloaliphatic amines, polyamides, dicyandiamide, tertiary amines, and imidazoles. Other curing agents include 9,9-bis(aminophenyl)fluorene and derivatives thereof. Selection of the curing agent can be based on the desired reactivity, cure temperature, viscosity of the curing mixture, along with the chemical resistance and mechanical properties of the end product.

In some embodiments, the epoxy resin includes one or more polyglycidyl ethers of polyhydric phenols and at least one 9,9-bis(aminophenyl)fluorene or derivative therefrom. Optionally, the epoxy resin composition further contains a sufficient amount of a conventional curing agent for epoxy resins, such as a polyamino group-containing compound and/or a conventional epoxy resin curing catalyst contains 10 to 100 percent, preferably 25 to 100 percent,

Where used, the 9,9-bis(aminophenyl)fluorene or derivative therefrom can be any suitable weight fraction of the adhesive, such as 0.01 wt % to 10 wt %; 0.1 wt % to 7 wt %; 0.5 wt % to 3 wt %; or in some embodiments less than, equal to, or greater than 0.01 wt %, 0.05, 0.1, 0.2, 0.5, 0.7, 1, 1.5, 2, 2.5, 3, 3.5, 4, 4.5, 5, 6, 7, 8, 9, or 10 wt %, relative to the overall weight of the adhesive.

If desired, the epoxy resin may be mixed with one or more additional components, such as catalysts, rheology control agents, tackifiers, fillers, elastomeric toughening agents, reactive diluents, and soluble thermoplastics, based on the knowledge of one skilled in the art.

### Silicones

The adhesives of the present invention can also contain a polymer based on a silicone (i.e., silicone resin). These resins are synthetic compounds made from chains of alternating silicon atoms and oxygen atoms, with organic groups attached to the silicon atoms.

Silicone resins are known to display excellent thermal and oxidative stability and a broad service temperature range (i.e., a temperature range in which the adhesive is useful) of −80° C. to 200° C. Advantageously, silicone resins are generally resistant to a wide variety of polar chemicals and solvents, for example, water, methanol, ethanol, acetonitrile/water, and dimethyl sulfoxide.

A silicone resin can be prepared from the following components: (a) a polydiorganosiloxane having the structure III below:

R¹R²SiO(R²SiO)ₙSiR²R¹ (III)

wherein each R is independently a monovalent hydrocarbon group, each R¹ is independently an alkenyl group and n is an integer, (b) an organopolysiloxane (often designated as an MQ resin) which contains (R²)₃SiO_{1/2} units (often designated as M units) and SiO₂ units (often designated as Q units) in a molar ratio in the range of 0.6:1 to 0.9:1, wherein each R² is independently selected from the group of alkyl groups, alkenyl groups, or hydroxyl groups, wherein at least 95 mole percent of all R² groups are methyl groups; (c) an organohydrogenpolysiloxane free of aliphatic unsaturation having an average of at least 2 silicon-bonded hydrogen atoms in each molecule, in a quantity sufficient to provide from 1 to 40 silicon-bonded hydrogen atoms per alkenyl group in component (a) and component (b) if present; and (d) a platinum-containing catalyst in a quantity sufficient to provide 0.1 to 1,000 weight parts platinum for each one million weight parts of the combined quantity of components (a) through (c).

For certain embodiments of the present invention, similar and preferred adhesives can be used wherein: the hydrocarbon groups of the above formula can be alkyl and alkenyl groups, etc., up to, for example, groups containing 10 carbon atoms; the alkyl groups can be methyl, ethyl, propyl, hexyl, etc., up to, for example, groups containing 10 carbon atoms; the alkenyl groups can be vinyl, propenyl, hexenyl, etc., up to, for example, groups containing 10 carbon atoms; the molar ratio of M to Q units in the MQ resin is in the range of 0.6:1 to 1:1; and a Group VIIIB-containing metal catalyst.

Depending on the choice of m and n, such materials can have an alkenyl (e.g., R′) equivalent weight of 250 g/mol to 10,000 g/mol, 250 g/mol to 5000 g/mol, 250 g/mol to 2000 g/mol, or in some embodiments, less than, equal to, or greater than 250 g/mol, 300, 350, 400, 450, 500, 600, 700, 800, 900, 1000, 1100, 1200, 1300, 1400, 1500, 1600, 1700, 1800, 1900, or 2000 g/mol.

Suitable polydiorganosiloxanes having a number average molecular weight of at least 20,000 are commercially available from sources such as Gelest Inc., Tullytown, Pa. Examples are disclosed in U.S. Pat. No. 5,082,706 (Tangney). The molecular weight of the polydiorganosiloxane can be at least 50,000 g/mol, at least 100,000 g/mol, or at least 250,000 g/mol.

Optionally, to adjust the release force and/or tack, a low molecular weight vinyl-substituted siloxane having a number average molecular weight of less than 20,000 g/mol can be added to the adhesive composition. If so, the high molecular weight polydiorganosiloxane component (i.e., having a number average molecular weight of at least 20,000 g/mol) is preferably present in the adhesive compositions in an amount of at least 50 weight parts and no greater than 95 weight pails, and the low molecular weight polydiorganosiloxane component (i.e., having a number average molecular weight of less than 20,000 g/mol) is preferably present in the adhesive compositions in an amount of at least 5 weight parts and no greater than 50 weight parts, based on the total parts by weight the high and low molecular weight polydiorganosiloxanes.

Suitable functional and nonfunctional MQ organopolysiloxane resins are commercially available from sources such as General Electric Co, Silicone Resins Division, Waterford, N.Y.; PCR, Inc., Gainesville, Fla., and Rhone-Poulenc, Latex and Specialty Polymers, Rock Hill, S.C.

Further details concerning silicone resins are described in U.S. Pat. No. 5,082,706 (Tangney) and U.S. Pat. No. 6,703,120 (Ko et al.).

### Methods and Applications

The adhesion promoter can be applied to the substrate using any known method. Known methods include standard coating techniques such as bar coating, roll coating, knife coating curtain coating, rotogravure coating, spraying and dipping. The substrate may be treated prior to coating to obtain a uniform coating or to promote adhesion using techniques such as corona discharge, plasma, flame treatment, or other oxidizing processes.

To further improve adhesion, some degree of mechanical retention between the adhesive and underlying substrate can be provided by roughening the surface of the PEKK-containing substrate before applying the adhesion promoter to the bonding surface. Surface roughening can be achieved mechanically, such as by abrading the surface of the substrate with sandpaper, a polishing stone, or other abrasive. Roughening may also be accomplished by chemical means, such as by etching by a wet chemical or a reactive gas, such as by plasma etching.

If only a very thin layer of adhesion promoter is required, the adhesion promoter can be disposed on the polyetherketoneketone-containing substrate by solution casting. In solution casting process, the adhesion promoter can be initially dispersed or dissolved into a solvent or combination of solvents compatible with the substrate. The adhesion promoter solution is then sprayed, dipped, brushed, wiped, or otherwise disposed onto the substrate and the solvent(s) evaporated, optionally under heat or vacuum, to provide a uniform layer of the adhesion promoter.

The particular solvent or solvents used in solution casting are preferably volatile, produce a stable solution/dispersion, and capable of providing a homogenous film on the substrate. Suitable solvents for polyamide adhesion promoters include isopropyl alcohol, propyl alcohol, and mixtures thereof. Suitable solvents for organotitanate adhesion promoters include ethyl alcohol, methyl alcohol, isopropyl alcohol, methyl isobutyl ketone, water, and mixtures thereof. Surface-treated nanosilica can be directly cast from an aqueous sol.

Lightning strike film is an application particularly enabled on PEKK composite structures by the particular adhesives and adhesion promoters described herein. In an exemplary method, a lightning strike film can be made by embedding an electrical conductor in a layer of an adhesive, enhancing bond strength of the adhesive to a PEKK-containing substrate according through the use of an adhesion promoter layer as described above, and then bonding the layer of adhesive to the PEKK-containing substrate to obtain the lightning strike film.

In the aforementioned method, the adhesive may be a thermoset adhesive based on an epoxy resin, a polysulfide, or polythioether. Such a thermoset adhesive may be coated in the form of a liquid and cured directly on the PEKK-containing substrate. Alternatively, the adhesive may be a pressure-sensitive adhesive having an embedded electrical conductor that is laminated to the PEKK-containing substrate in the form of a dimensionally-stable adhesive film.

Objects and advantages of this disclosure are further illustrated by the following non-limiting examples, but the particular materials and amounts thereof recited in these examples, as well as other conditions and details, should not be construed to unduly limit this disclosure.

While not intended to be exhaustive, further enumerated embodiments are provided below:
1. A multilayered article comprising: a substrate comprising polyetherketoneketone; an adhesion promoter disposed on the substrate, the adhesion promoter comprising at least one of organotitanate, polyamide, surface-treated nanosilica, aminosilane, or epoxy silane; and an adhesive bonded to the adhesion promoter, the adhesive comprising at least one of an acrylic polymer, a polysulfide, a polythioether, an epoxy resin, or a silicone resin.
2. The multilayered article of embodiment 1, wherein the adhesive is a thermoset adhesive.
3. The multilayered article of embodiment 2, wherein the thermoset adhesive contains an embedded electrical conductor.
4. The multilayered article of embodiment 3, wherein the embedded electrical conductor comprises a foraminous metal foil.
5. The multilayered article of embodiment 4, further comprising a backing disposed on the thermoset adhesive, the backing comprising a fluoropolymer.
6. The multilayered article of any one of embodiments 1-5, wherein the adhesion promoter comprises organotitanate and the adhesive comprises a polysulfide or polythioether.
7. The multilayered article of any one of embodiments 1-5, wherein the adhesion promoter comprises epoxy silane and the adhesive comprises an epoxy resin.
8. The method of embodiment 7, wherein the epoxy is a curable epoxy resin.
9. The method of embodiment 8, wherein the curable epoxy is curable by actinic radiation.
10. The method of embodiment 8, wherein the curable epoxy is chemically curable.
11. The multilayered article of embodiment 1, wherein the adhesive is a pressure-sensitive adhesive.
12. The multilayered article of embodiment 1 or 11, wherein the adhesion promoter comprises polyamide and the adhesive comprises an acrylic polymer.
13. The multilayered article of any one of embodiments 1, 11, and 12, wherein the adhesion promoter comprises surface-treated nanosilica and the adhesive comprises a silicone resin.
14. The multilayered article of embodiment 13, wherein the surface-treated nanosilica is treated with an organosilane.
15. The multilayered article of embodiment 13 or 14, wherein the nanosilica has a median diameter of from 100 nanometers to 500 nanometers.
16. The multilayered article of embodiment 13 or 14, wherein the nanosilica has a median diameter of from 20 nanometers to 100 nanometers.
17. The multilayered article of embodiment 13 or 14, wherein the nanosilica has a median diameter of from 5 nanometers to 20 nanometers.
18. The multilayered article of any one of embodiments 1 and 11-17, wherein the adhesion promoter comprises aminosilane and the adhesive comprises a silicone resin.
19. The multilayered article of embodiment 18, wherein the aminosilane is a primary amine.
20. The multilayered article of any one of embodiments 1-19, wherein the polyetherketoneketone is a resin matrix in fiber-reinforced composite.
21. The multilayered article of any one of embodiments 1-20, wherein the adhesion promoter is present in a layer having an average thickness of up to 10 nanometers.
22. The multilayered article of embodiment 21, wherein the adhesion promoter is present in a layer having an average thickness of up to 5 nanometers.
23. The multilayered article of embodiment 22, wherein the adhesion promoter is present in a layer having an average thickness of up to 1 nanometer.
24. The multilayered article of any one of embodiments 1-23, wherein the substrate is part of an aircraft fuselage, aircraft propeller, composite fan, helicopter rotor blade, engine nacelle, aircraft wing, aircraft stabilizer, or wind generator blade.
25. The multilayered article of any one of embodiments 1-24, wherein the adhesive is present in a layer having an average thickness of from 8 micrometers to 450 micrometers.
26. The multilayered article of embodiment 25, wherein the adhesive is present in a layer having an average thickness of from 12 micrometers to 250 micrometers.
27. The multilayered article of embodiment 26, wherein the adhesive is present in a layer having an average thickness of from 15 micrometers to 100 micrometers.
28. A method of enhancing bond strength of an adhesive to a polyetherketoneketone-containing substrate, the method comprising: disposing an adhesion promoter on the polyetherketoneketone-containing substrate, the adhesion promoter comprising at least one of organotitanate, polyamide, surface-treated nanosilica, aminosilane, or epoxy silane.
29. The method of embodiment 28, wherein the adhesion promoter comprises organotitanate and the adhesive comprises a polysulfide or polythioether.
30. The method of embodiment 28, wherein the adhesion promoter comprises epoxy silane and the adhesive comprises an epoxy resin.
31. The method of embodiment 30, wherein the epoxy silane comprises glycidoxypropyltrimethoxysilane.
32. The method of embodiment 28, wherein the adhesion promoter comprises polyamide and the adhesive comprises an acrylic polymer.
33. The method of embodiment 28, wherein the adhesion promoter comprises surface-treated nanosilica and the adhesive comprises a silicone resin.
34. The method of embodiment 28, wherein the adhesion promoter comprises aminosilane and the adhesive comprises a silicone resin.
35. The method of any one of embodiments 28-34, wherein disposing an adhesion promoter onto the polyetherketoneketone-containing substrate comprises solution casting the adhesion promoter onto the polyetherketoneketone-containing substrate.
36. The method of any one of embodiments 35, wherein the adhesion promoter comprises polyamide and the polyamide is solution cast from a solvent comprising isopropyl alcohol, propyl alcohol, or a mixture thereof.
37. The method of any one of embodiments 35, wherein the adhesion promoter comprises organotitanate and the organotitanate is solution cast from a solvent comprising ethyl alcohol, methyl alcohol, isopropyl alcohol, methyl isobutyl ketone, water, or a mixture thereof.
38. The method of any one of embodiments 35, wherein the adhesion promoter comprises surface-treated nanosilica and the surface-treated nanosilica is solution cast from water.
39. The method of any one of embodiments 28-38, further comprising mechanically abrading a surface of the polyetherketoneketone-containing substrate onto which the adhesion promoter is subsequently disposed.
40. The method of any one of embodiments 28-39, wherein the adhesion promoter provides an increase in peel adhesion strength of from 10 percent to 500 percent based on the 180° Peel Adhesion Test.
41. A method of making a lightning strike film comprising: embedding an electrical conductor in a layer of adhesive; enhancing bond strength of the adhesive to a polyetherketoneketone-containing substrate according to the method of any one of embodiments 28-40; and bonding the layer of adhesive to the polyetherketoneketone-containing substrate to obtain the lightning strike film.
42. The method of embodiment 41, wherein the polyetherketoneketone-containing substrate comprises a fiber-reinforced composite with a polyetherketoneketone matrix.
43. The method of embodiment 41 or 42, wherein the adhesive comprises a thermoset adhesive and wherein bonding the layer of adhesive comprises curing the thermoset adhesive against the polyetherketoneketone-containing substrate.
44. The method of embodiment 43, wherein the thermoset adhesive comprises an epoxy resin.
45. The method of any one of embodiments 41-44, wherein the electrical conductor comprises foraminous metal foil.

### EXAMPLES

Unless otherwise noted, all parts, percentages, ratios, etc. in the Examples and the rest of the specification are by weight.

TABLE 1
Materials

| | Description | Source |
|---|---|---|
| Designation | 3M PAINT REPLACEMENT TAPE 5004 | 3M Co., St. Paul, MN |
| 1.65EDCU12-100FA | A foraminous copper screen, available | Dexmet Corp., 7 Great Hill |
| | under the identifier “1.65EDCU12- | Road, Naugatuck, CT |
| | 100FA” | |
| 3,4-DMT | 2,4-bis(trichloromethyl)-6-(3,4- | TCI America, Portland, OR |
| | dimethoxy)phenyl-s-triazine (CAS No. | |
| | 80050-87-9), available from TCI America | |
| 3-Glycidoxypropyl | 3-Glycidoxypropyl trimethoxysilane | Alfa Aesar, Ward Hill, MA |
| trimethoxysilane | | |
| 3M ADHESION | A polyamide resin liquid primer for use | 3M Co., St. Paul, MN |
| PROMOTER 86A | with adhesives, available under the | |
| | trade designation “3M ADHESION | |
| | PROMOTER 86A” | |
| 3M PAINT | A fluoropolymer tape having acrylic | 3M Co., St. Paul, MN |
| REPLACEMENT TAPE | adhesive, available under the trade | |
| 5004 | designation “3M PAINT REPLACEMENT | |
| | TAPE 5004” | |
| 3M PROTECTIVE TAPE | A pre-mixed tape application solution to | 3M Co., St. Paul, MN |
| APPLICATION | provide adhesion for polyurethane | |
| SOLUTION | protective tape | |
| 4AL8-080F | A foraminous aluminum foil, available | Dexmet Corp., 7 Great Hill |
| | under the trade designation “4AL8- | Road, Naugatuck, CT |
| | 080F” | |
| 6040 Silane | A silane coupling agent/adhesion | Dow Corning, Midland, MI |
| | promoter, available under the trade | |
| | designation “XIAMETER OFS-6040 | |
| | Silane” | |
| 810 MOMENTIVE | A silicone adhesive available under the | Momentive Specialty |
| SILICONE ADHESIVE | trade designation “810 MOMENTIVE | Chemicals, Waterford, NY |
| | SILICONE ADHESIVE” | |
| A187 | Glycidoxypropyltrimethoxysilane, | AB Specialty Silicones, |
| | available under the trade designation | Waukegan, IL |
| | “ANDISIL 187 SILANE” | |
| AA | Acrylic acid | 3M Co., St. Paul, MN |
| AC-137 | An organotitanate adhesion promoter, | 3M Co., St. Paul, MN |
| | clear, available under the trade | |
| | designation “3M AC-137 ADHESION | |
| | PROMOTER” | |
| AC-350 | A polysulfide sealant, available under | 3M Co., St. Paul, MN |
| | the trade designation “3M AC-350 | |
| | AEROSPACE SEALANT” | |
| AC-X92 | Thiol-terminated polythioether | |
| | oligomer with the equivalent weight of | |
| | 1482 g/mol synthesized as described in | |
| | “Polythioether Example 1” in PCT Publ. | |
| | No. WO 2016/130673 | |
| AlEA | Aluminum di-s-butoxide- | Gelest, Inc. Morrisville, PA |
| | ethylacetoacetate | |
| APS | 3-aminopropyltriethoxysilane | Alfa Aesar, Ward Hill, MA |
| DABCO | 1,4-diazabicyclo[2.2.2]octane | Alfa Aesar, Ward Hill, MA |
| DAEBPA | Diallyl ether of bisphenol A | Bimax, Glen Rock, PA |
| DYNEON THV 200 | A terpolymer of tetrafluoroethylene, | 3M Co., St. Paul, MN |
| | hexafluoropropylene, and vinylidene | |
| | fluoride, available under the trade | |
| | designation “DYNEON THV 200” | |
| DYNEON THV 500 | A terpolymer of tetrafluoroethylene, | 3M Co., St. Paul, MN |
| | hexafluoropropylene, and vinylidene | |
| | fluoride, available under the trade | |
| | designation “DYNEON THV 500” | |
| EPON 1001F | A low molecular weight solid epoxy | Momentive Specialty |
| | resin derived from a liquid epoxy resin | Chemicals, Waterford, NY |
| | and bisphenol-A, available under the | |
| | trade designation “EPON 1001F” | |
| EPON 828 | A difunctional bisphenol A/ | Momentive Specialty |
| | epichlorohydrin-derived liquid epoxy | Chemicals, Waterford, NY |
| | resin, available under the trade | |
| | designation “EPON 828” | |
| FUMSIL | Fumed silica filler, available under the | Wacker Chemical Corp., |
| | trade designation “HDK H2000” | Adrian, MI |
| GLABUB2 | Glass bubbles, available under the trade | 3M Co., St. Paul, MN |
| | designation “3M iM16K HI-STRENGTH | |
| | GLASS BUBBLES” | |
| Gray pigment | Gray pigment master batch | Americhem Inc., Elgin, IL |
| HDDA | 1,6-Hexanediol diacrylate | Sigma-Aldrich Chemical |
| | | Co., Milwaukee, WI |
| IOA | Isooctyl acrylate | 3M Co., St. Paul, MN |
| IRGACURE 651 | A photoinitiator, available under the | BASF, Ludwigshafen, |
| | trade designation “IRGACURE 651” | Germany |
| K1003 | Vinyltrimethoxysilane, available under | Shin-Etsu Chemical, Tokyo, |
| | the trade designation “KBM-1003” | Japan |
| L-7604 | An organosilicone surface tension | Momentive Specialty |
| | reducing agent, available under the | Chemicals, Waterford, NY |
| | trade designation “SILWET L-7604” | |
| MEK | Methyl ethyl ketone | VWR, Radnor, |
| | | Pennsylvania |
| MeOH | Methanol | VWR, Radnor, |
| | | Pennsylvania |
| MX 154 | Core-shell rubber particles dispersed in | Kaneka North America |
| | an epoxy resin, available under the | LLC, Pasadena, TX |
| | trade designation “KANE ACE MX-154” | |
| NALCO 2326 | Silica nanoparticles, 14.5 wt. % | Nalco Co., Naperville, IL |
| | dispersion in water, available under the | |
| | trade designation “NALCO 2326” | |
| NISSAN IPA-ST-UP | Silica nanoparticles, 9-15/40-100 nm, | Nissan Chemical America |
| | 16.5 wt. % solids in isopropyl alcohol, | Corp., Houston, TX |
| | available under the trade designation | |
| | “NISSAN IPA-ST-UP” | |
| OR819 | Phenylbis(2,4,6- | IGM resins, St. Charles, IL |
| | trimethylbenzoyl)phosphine oxide | |
| | available under the trade designation | |
| | “OMNIRAD 819” | |
| PENNCO | A blue pigment (13.5-16.5 wt. %) | Penn Color, Inc., |
| | dispersed in acrylic resin, available | Doylestown, PA |
| | under the product code “69S3489” from | |
| | Penn Color, Inc. | |
| PKHP-200 | A micronized phenoxy resin, available | Inchem Corp, Rock Hill, SC |
| | under the trade designation “PHENOXY | |
| | RESIN PAPHEN PKHP-200” | |
| PSA 811 | A silicone pressure sensitive adhesive, | Momentive Specialty |
| | available under the trade designation | Chemicals, Waterford, NY |
| | “Silicone PSA 811” | |
| PVDF 11010 | A copolymer of vinylidine fluoride and | 3M Co., St. Paul, MN |
| | hexafluoropropylene, available under | |
| | the trade designation “3M DYNEON | |
| | PVDF 11010/0000” | |
| S322 | Coated calcium carbonate, available | Solvay Chemicals, |
| | under the trade designation “SOCAL | Houston, TX |
| | 332” | |
| TAIC | Triallyl isocyanurate | Tokyo Chemical Industry |
| | | Co., Portland, OR |
| TBEC | tert-Butylperoxy 2-ethylhexyl carbonate | Sigma -Aldrich, St. Louis, |
| | | MO |
| TCDM | A tricyclodecane alcohol dimethanol, | Oxea-Chemicals, Farmers |
| | available under the trade designation | Branch, TX |
| | “TCD ALCOHOL DM” | |
| TEOS | tetraethoxysilane | Alfa Aesar, Ward Hill, MA |
| THV-610 Film | A fluoroplastic film of | 3M Co., St. Paul, MN |
| | tetrafluoroethylene, | |
| | hexafluoropropylene, and vinylidene | |
| | fluoride (THV) terpolymer, available | |
| | under the trade designation “THV-610” | |
| TMOS | tetramethoxysilane | Alfa Aesar, Ward Hill, MA |
| TnBB-MOPA | Tri-n-butylborane methoxypropylamine | BASF Chemical Co., |
| | | Ludwigshafen, Germany |
| UVI 6976 | A cationic photoinitiator containing a | Dow Chemical Company, |
| | mixture of triarylsulfonium | Midland, MI |
| | hexafluoroantimonate salts in | |
| | propylene carbonate, available under | |
| | the trade designation “CYRACURE UVI | |
| | 6976” | |
| UVTS-52 | An azodioxide, inhibitor in UV catalyzed | Hamford Research, |
| | polymerization, available under the | Stratford, CT |
| | trade designation “HRI UVTS-52” | |
| X-100 | A surfactant, available under the trade | Sigma Chemical Co., St. |
| | designation “X-100” | Louis, MO |

### Peel Adhesion Strength Test Method

Coupons having applied test strips thereon were evaluated for peel adhesion strength at room temperature (24° C.). Specifically, coupons were tested according to PSTC-1 (11/75). The tab end of each strip was lifted to expose the longitudinal edge of the coupon. The longitudinal edge of the coupon was then clamped in the jaws of a tensile testing machine (Instron Universal Testing Instrument MODEL #4201 equipped with a 1 kN STATIC LOAD CELL, available from Instron Company Corporation, Canton, Mass.). The tab of the test strip was attached to the load cell and peeled at an angle of 180° and at a rate of 30.5 cm/minute. The peel adhesion force required to remove the test strip from the coupon was recorded in ounces and the average value between 5.1 cm and 7.6 cm was taken. The results were combined to give an average value, and the average value was also converted in to units of Newton/25 mm (N/25 mm), using the conversion 4.378*(value in lb/in)=(value in N/25 mm).

### NANOPLAST Treatment—Nanostructure Creation by Plasma Treatment

The nanostructures of this invention were generated by using a homebuilt plasma treatment system described in detail in U.S. Pat. No. 5,888,594 (David et al.) with some modifications. The width of the drum electrode was increased to 42.5 inches (108 cm) and the separation between the two compartments within the plasma system was removed so that all the pumping was carried out by means of the turbo-molecular pump and thus operating at a process pressure of around 10 mTorr (1.3 Pa).

The film was mounted within the chamber and wrapped around the drum electrode. The unwind and take-up tensions were maintained at 4 pounds (18 N) and 10 pounds (45 N) respectively. The chamber door was closed and the chamber pumped down to a base pressure of 5×10⁻⁴ torr (0.07 Pa). For the plasma treatment, hexamethyldisiloxane (HMDSO) and oxygen were introduced at a flow rate of 30 standard cm3/min and 750 standard cm3/min respectively, and the operating pressure was nominally at 13 mTorr (1.7 Pa). Plasma was turned on at a power of 7500 watts by applying rf power to the drum. The drum rotation was set so that the film was transported at a speed of 10 feet/min (3.0 m/min). The run was continued until the entire length of the film on the roll was completed.

After the entire roll of film was treated in the above manner, the rf power was disabled, oxygen flow stopped, chamber vented to the atmosphere, and the roll taken out of the plasma system.

### Comparative Example 1 (CE-1)

An applique was provided in the following manner. A premix acrylic syrup was prepared by combining in a 4.0-liter glass jar 1550 grams of isooctyl acrylate (IOA), 172 grams of acrylic acid (AA), and 60 0.7 gram IRGACURE 651 photoinitiator. The jar was capped and a nitrogen source placed into the mixture through a hole in the cap. After purging with nitrogen for 10 minutes the mixture was gently swirled and exposed to ultraviolet (UV) irradiation using two 15 Watt blacklight 65 bulbs (Sylvania Model F15T8/350BL) until a syrup having a visually estimated viscosity of about 1000 centipoise was obtained. The nitrogen purge and irradiation were then discontinued and 3.1 grams of hexanediol diacrylate (HDDA), 3.0 grams of 2,4-bis(trichloromethyl)-6-(3,4-dimethoxy)phenyl-s-triazine (3,4-DMT) and 3.4 grams of IRGACURE 651 were added to the premix syrup and dissolved therein by placing the combination, in a sealed jar, on a roller for 30 minutes to give a final acrylic syrup.

A gray fluoropolymer backing was prepared by feeding a uniform mixture of pellets having 97 percent (w/w) clear DYNEON THV 500 and 3 percent (w/w) of gray pigmented DYNEON THV 200 (this pigmented material was prepared by Americhem, Incorporated, Elgin, Ill., such that the color of the resultant gray backing met the specifications for Federal Standard 595B, Color Number. 36320) into an extruder. The uniform mixture was extruded to a thickness of 88.9 micrometers+/−12 micrometers onto a smooth 51 micrometers thick polyester carrier web using a Haake extruder having a screw diameter of 1.9 cm and a die width of 20.3 cm, and employing a screw speed of 165 rpm and a web speed of 1.8 meters/minute. The extruder die was held approximately 1.9 cm away from the carrier. The extruder had three zones which were set at 224° C. in zone 1, 243° C. in zone 2, and 246° C. in zone 3; the die temperature was set at 246° C. Next, the top surface of the backing was treated by Acton Technologies, Inc., Pittston, Pa., using their FLUOROETCH etching process.

The above final acrylic syrup was then coated against the etched surface of the fluoropolymer backing using a knife-over-bed coating station. The knife was locked in position to maintain a fixed gap of 76.2 micrometers greater than the combined thickness of the fluoropolymer backing and the carrier web employed. The syrup coated fluoropolymer backing was then cured by passing it through a 9.1 meters long UV irradiation chamber having bulbs mounted in the top which had a spectral output from 300 nanometers to 400 nanometers, with a maximum at 351 nanometers. The temperature setpoint was 15.5° C. and the bulbs were set at an intensity of 3.1 milliWatts/centimeter². The chamber was continuously purged with nitrogen. The web speed through the coating station and irradiation chamber was 4.6 meters/minute resulting in a total measured energy dosage of 368 milliJoules/centimeter² (National Institute of Standards and Technology (NIST) units). After irradiation from the adhesive side, the final combined thickness of the cured adhesive and backing was approximately 139.7 micrometers, indicating a cured adhesive thickness of about 50.8 micrometers. A 101.6 micrometers thick polyethylene release liner was then laminated onto the exposed side of the adhesive.

Next, the polyester carrier web was removed and the second, opposing surface of the backing was treated by Acton Technologies, Inc. using their FLUOROETCH process.

A major surface of a polyetherketoneketone (“PEKK”) panel measuring 200 mm by 200 mm by 2.4 mm thick was cleaned with IPA and wiped dry. The release liner was removed from a portion of the applique fabricated according to this example and the adhesive side of the applique was laminated to the panel. Pressure was applied during lamination with a squeegee. After 24 hours dwell time, adhesion was evaluated as “Peel Adhesion Strength” as described above. Results were as summarized in Table 2.

TABLE 2

| Sample | Average 180° Peel Adhesion Strength, oz/in (N/25 mm) |
|---|---|
| CE-1 | 2.27 (0.631) |
| EX-1 | 40.18 (11.17) |
| EX-2 | 48.21 (13.41) |
| EX-3 | 24.53 (6.821) |

### Comparative Example 2 (CE-2)

Comparative Example 1 was repeated with the following modification. A sheet of aluminum foil perforated and expanded to a foraminous screen identifiable as 4AL8-080F (from Dexmet Corporation, 7 Great Hill Road, Naugatuck, Conn.) was placed against the etched surface of the fluoropolymer backing before the final acrylic syrup was coated. The acrylic syrup was coated onto the foraminous aluminum foil with the knife was locked in position to maintain a fixed gap of 114.3 micrometers greater than the combined thickness of the fluoropolymer backing and the carrier web employed.

### Example 1 (EX-1)

Part A and Part B of 3M AC-350 Polysulfide were blended at 1:10 by volume for 3 minutes. The blended adhesive was coated against the exposed surface of 1.0 mil (25 micrometers) thick THV 500 film, using a knife-over-bed coating station. The knife was locked in position to maintain a fixed gap of 76.2 micrometers greater than the combined thickness of the fluoropolymer backing and its carrier web. A sheet of expanded copper foil, perforated and expanded to a foraminous screen 175 gsm, identifiable as 1.65EDCU12-100FA, was laminated into the coated web.

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. The surface of the PEKK panel was wiped with 3M Adhesion Promoter AC-137 Clear and let dry 5 minutes. The coated web made above was placed against the prepared surface of the PEKK panel. Laminated the materials together using a squeegee to apply pressure and cured 24 hours.

### Example 2 (EX-2)

Part A and Part B of 3M AC-350 Polysulfide were blended at 1:10 by volume for 3 minutes. The blended adhesive was coated against the PMMA rich surface of 1.0 mil (25 micrometers) thick PMMA/PVDF film (an extruded bilayer film having an 80:20 blend of PMMA/PVDF on one major surface, and a 20:80 blend of PMMA/PVDF on the opposite major surface), using a knife-over-bed coating station. The knife was locked in position to maintain a fixed gap of 76.2 micrometers greater than the combined thickness of the fluoropolymer backing and its carrier web. A sheet of expanded copper foil, perforated and expanded to a foraminous screen 175 gsm, identifiable as 1.65EDCU12-100FA, was laminated into the coated web.

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. Wiped the surface of the PEKK with 3M Adhesion Promoter AC-137 Clear and let dry 5 minutes. Placed the coated web against the prepared surface of the PEKK panel. Laminated the materials together using a squeegee to apply pressure and cured 24 hours. “Peel Adhesion Strength” was evaluated as described above, and results were as summarized in Table 2.

### Example 3 (EX-3)

Part A and Part B of 3M AC-350 Polysulfide were blended at 1:10 by volume for 3 minutes. The blended adhesive was coated against the PMMA rich surface of 0.7 mil (18 micrometers) thick PMMA/PVDF film (an extruded bilayer film having an 80:20 blend of PMMA/PVDF on one major surface, and a 20:80 blend of PMMA/PVDF on the opposite major surface), using a knife-over-bed coating station. The knife was locked in position to maintain a fixed gap of 76.2 micrometers greater than the combined thickness of the fluoropolymer backing and its carrier web. A sheet of expanded copper foil, perforated and expanded to a foraminous screen 175 gsm, identifiable as 1.65EDCU12-100FA, was laminated into the coated web. The carrier film was removed from the PVDF film.

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. Wiped the surface of the PEKK with 3M Adhesion Promoter AC-137 Clear and let dry 5 minutes. Placed the coated web against the prepared surface of the PEKK panel. Laminated the materials together using a squeegee to apply pressure and cured 24 hours. “Peel Adhesion Strength” was evaluated as described above, and results were as summarized in Table 2.

### Example 4 (EX-4)

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. A “wet application” process was carried out as follows: (1) Applied 3M PROTECTIVE TAPE APPLICATION SOLUTION to the surface of the PEKK; (2) Removed the liner from 3M PAINT REPLACEMENT TAPE 5004; and (3) applied the adhesive side to the wetted surface of the PEKK panel. Laminated the materials together using a squeegee to apply pressure. “Peel Adhesion Strength” was evaluated as described above, and results were as summarized in Table 3.

### Example 5 (EX-5)

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. A “dry application” process was carried out as follows: (1) Applied polyamide resin 3M ADHESION PROMOTER 86A to the surface of the PEKK and dried at RT for 5 minutes; (2) Applied 3M PROTECTIVE TAPE APPLICATION SOLUTION to the surface of the PEKK; (3) Removed the liner from a piece of 3M PAINT REPLACEMENT TAPE 5004; and (4) applied the adhesive side to the wetted surface of the PEKK panel. Laminated the materials together using a squeegee to apply pressure. “Peel Adhesion Strength” was evaluated as described above, and results were as summarized in Table 3.

TABLE 3

| | | | | 180° Peel |
|---|---|---|---|---|
| | | | | Adhesion |
| | | | | Strength, |
| | | | | lbs/in |
| | | Sub- | | (N/25 |
| Sample | Tape | strate | Prep Method | mm) |
| EX-4 | 3M PAINT | PEKK | 320 grit | 4.3 (19) |
| | REPLACEMENT | panel | sanding + | |
| | TAPE 5004 | | “wet application” | |
| EX-5 | 3M PAINT | PEKK | 320 grit | 5.3 (23) |
| | REPLACEMENT | panel | sanding + | |
| | 5004 5004 | | “dry application” | |

### Example 6 (EX-6)

A 0.7 mil (18 micrometers) thick PVDF 11010 film was treated on the exposed surface with NANOPLAST treatment. Part A and Part B of 3M AC-350 polysulfide were blended at 1:10 by volume for 3 minutes. The blended adhesive was coated onto the treated surface of the 0.7 mil (18 micrometers) PVDF film using a knife-over-bed coating station. The knife was locked in position to maintain a fixed gap of 76.2 micrometers greater than the combined thickness of the fluoropolymer backing and its carrier web. A sheet of expanded copper foil, perforated and expanded to a foraminous screen 175 gsm, identifiable as 1.65EDCU12-100FA, was laminated into the coated web. The carrier film was removed from the PVDF film.

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. Wiped the surface of the PEKK with 3M ADHESION PROMOTER AC-137 CLEAR and let dry 5 minutes. Placed the coated web against the prepared surface of the PEKK panel. Laminated the materials together using a squeegee to apply pressure and cured 24 hours.

### Example 7 (EX-7)

100 grams Part A (for ingredients, see Table 4) and 17.12 grams of Part B (for ingredients, see Table 5) of a polythioether sealant (prepared similarly as that polythioether sealant described in Example 17 of U.S. Provisional Patent Application No. 62/563,231, filed on Sep. 26, 2017) were blended in an appropriately sized DAC speed mixing cup on a model DAC 400 FVZ Speedmixer (FlackTek, Inc., Landrum, S.C.). The sealant was mixed at 1600 RPM for 20 seconds, hand mixed for 15-30 seconds, and then mixed again at 1600 RPM for 20 seconds. The blended polythioether sealant was coated against the exposed surface of 1.0 mil THV backing using a knife-over-bed coating station. The knife was locked in position to maintain a fixed gap of 76.2 micrometers greater than the combined thickness of the fluoropolymer backing and its carrier web. A sheet of perforated and expanded 175 gsm copper foil (product code 1.65EDCU12-100FA from Dexmet Corporation, Naugatuck, Conn.) was laminated into the coated web.

TABLE 4

| COMPONENT | AMOUNT, grams |
|---|---|
| AC-X92 | 248.97 |
| DABCO | 0.39 |
| TnBB-MOPA | 0.93 |
| FUMSIL | 4.98 |
| S322 | 54.77 |
| GLABUB2 | 9.96 |

TABLE 5

| | AMOUNT, |
|---|---|
| COMPONENT | grams |
| DAEBPA | 17.49 |
| TAIC | 2.21 |
| TBEC | 9.75 |
| PENNCO | 0.03 |
| OR819 | 1.21 |
| A187 | 8.58 |
| K1003 | 0.86 |
| FUMSIL | 2.86 |
| GLABUB2 | 20.02 |

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. The surface was treated with 3M ADHESION PROMOTER AC-137 Clear (3M Co., St. Paul, Minn.) and allowed to dry 15 minutes. The polythioether sealant and copper foil web made previously was applied to the prepared PEKK panel and a squeegee used to apply pressure to the resulting laminate. The laminate was allowed to cure at ambient temperature for 24 hours.

### Example 8 (EX-8)

### Preparation of An Adhesive Coating:

The components listed in Table 6 were added into an 8 ounce (237 milliliters) jar and rolled for 4 hours to dissolve all components, to provide an epoxy adhesive coating solution (Sample EX-8-A).

TABLE 6

| Material | Mass, grams |
|---|---|
| EPON 828 | 12.2 |
| MX 154 | 20.1 |
| EPON 1001F | 12.2 |
| S-7604 | 0.2 |
| TCDM | 5.3 |
| 6040 silane | 1.5 |
| PKHP-200 | 5 |
| UVTS-52 | 1 |
| UVI 6976 | 1 |
| MEK | 30 |

A 0.7 mil (18 micrometers) thick PVDF 11010 film was treated on the exposed surface with NANOPLAST treatment. The above epoxy adhesive coating solution was coated at 0.004 inch (0.1 mm) wet thickness via knife coating onto the PVDF film. The coating was allowed to dry for one hour at room temperature, creating an epoxy-coated PVDF film (Sample EX-8-B).

A second coating of epoxy adhesive coating solution (EX-8-A) was applied to a polycoated paper release liner at 0.004 inch (0.1 mm) thickness, wet. This coating was also allowed to dry at room temperature for one hour, creating an epoxy-coated release liner (Sample EX-8-C).

### ECF Treatment

175 gsm expanded copper foil (ECF), 1.65EDCU12-100FA, was wiped on both sides with a 2 wt. % solution of 6040 silane in MEK. The ECF was allowed to dry at room temperature for 5 minutes, creating a primed expanded copper foil (Sample EX-8-D)

### Film Lamination

A laminated article was formed by laminating the primed expanded copper foil (Sample EX-8-D) between the epoxy-coated PVDF film (Sample EX-8-B) and the epoxy-coated release liner (Sample EX-8-C), with the epoxy-coated surfaces facing the primed expanded copper foil layer. The lamination was performed using a continuous roll laminator at 80 psi (550 kPa), providing the laminated article (Sample EX-8-E).

### Panel Layup

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. The panel was then wiped with a solution of 2 wt. % of 6040 (silane) in MeOH and allowed to dry for 10 minutes at room temperature. The paper release liner was removed from the laminated article Sample EX-8-E, and the open adhesive side of the film was exposed to blue light with a wavelength of 365 nm. The sample was conveyed under a bank of blue light LEDs controlled by a CT2000 controller, available from Clearstone Technologies, Hopkins, Minn. The sample was situated on a belt positioned two inches (5 cm) from the LED lights and conveyed at a rate of three feet per minute to give an approximate radiant energy density of 3.62 J/cm². The activated adhesive was laminated by hand to the prepared panel and then placed in a vacuum bag and held under vacuum pressure of about 26 inHg (88 kPa) for one hour. After removal from the vacuum bag, the PEKK panel was subjected to the same blue light conditions as above, but this time the light was shined through the topside of the transparent, PVDF film.

### Preparative Example 1 (PE-1)

### Preparation of Aminosilane-Modified Silica Nanoparticles (Nanosilica):

Into a glass jar was placed 264.1 g deionized water. To the water solution was added 0.58 g concentrated ammonia. The ammonia solution was stirred and 40 g of such aqueous ammonia solution was transferred into a separated glass jar. To the remaining ammonia aqueous solution (224.1 g) was added surfactant X-100 (0.072 g) and NALCO 2326 (5.38 g, 14.5 wt %, available from Nalco Co.). The solution was stirred. To the transferred 40 g ammonia aqueous solution was added 3-aminopropyltriethoxysilane (0.24 g, neat), subsequently such solution was added to the above prepared NALCO 2326 nanosilica dispersion solution. The solution was stirred overnight and the resulting solution of surface modified silica nanoparticles was ready for use.

### Example 9 (EX-9)

A 0.7 mil (18 micrometers) thick PVDF 11010 film was treated on the exposed surface with NANOPLAST treatment. Knife coated Momentive 810 silicone adhesive (50 wt. % in toluene, with added benzoyl peroxide at 1.2 wt. % based on solids weight of Momentive 810) onto the treated surface of the 0.7 mil (18 micrometers) thick PVDF film. A sheet of expanded copper foil, perforated and expanded to a foraminous screen 175 gsm, identifiable as 1.65EDCU12-100FA, was laminated into the coated web. Another layer of the 810 Momentive silicone adhesive was knife coated onto the expanded copper foil. The carrier film was removed from the PVDF film.

A major surface of a PEKK panel (200 mm by 200 mm by 2.4 mm thick) was cleaned with IPA and wiped dry was abraded with a 3M HOOKIT Disc (3M Co., St. Paul, Minn.) on an orbital sander and cleaned with IPA and wiped dry. The above PE-1 solution of surface modified silica nanoparticles was wiped onto to the prepared surface of the PEKK panel. Applied the adhesive side of the above PVDF film to the PEKK panel. Laminated the materials together using a squeegee to apply pressure.

### Preparative Example 2 (PE-2): PVDF Silicone Adhesion Tape Preparation

Silicone PSA 811 50 wt. % in Toluene (obtained from Momentive Co.) was mixed with benzoyl peroxide (1.2 wt. % based on the solid wt. % of PSA 811) was coated on diamond-like glass-treated PVDF (polyvinylidene fluoride) film with a No. 12 Meyer bar and was subsequently cured at 140° C. for 10 minutes to result in a silicone-adhesive-coated PVDF film.

### Example 10 (EX-10)

A primer, comprising the aqueous aminosilane modified nanosilica solution of Preparative Example 1 above, was wiped with a cotton swab onto a clean panel of PEKK substrate, and was dried with a dryer at room temperature. A piece of the PVDF silicone adhesion tape prepared in PE-2 was laminated against the aqueous nanosilica primed PEKK by a roller at room temperature. The 180° Peel Adhesion value was obtained, as summarized in Table 7, noting transfer of pressure sensitive adhesive to the PEKK substrate.

TABLE 7

| | | 180° Peel Adhesion |
|---|---|---|
| Sample | Drying conditions | Strength, lbs/in (N/25 mm) |
| EX-10 | RT heat gun (no added heat) | 4.2 lb/in (18 N/25 mm), <10% |
| | | PSA transferred |
| EX-11 | 60° C., 2 min | 6.4 lb/in (28 N/25 mm), >80% |
| | | PSA transferred |
| EX-12 | 60° C., 10 min | 6.4 lb/in (28 N/25 mm), >80% |
| | | PSA transferred |

### Example 11 (EX-11)

The procedure of EX-10 was repeated, except that the drying conditions were 60° C. for 2 min. The 180° Peel Adhesion value was obtained, as summarized in Table 7, noting transfer of PSA to the PEKK substrate.

### Example 12 (EX-12)

The procedure of EX-10 was repeated, except that the drying conditions were 60° C. for 10 min. The 180° Peel Adhesion value was obtained, as summarized in Table 7, noting transfer of PSA to the PEKK substrate.

Other primer solutions were also prepared and tested, as described in the following examples EX-13 to EX-16.

### Example 13 (EX-13): Using a Primer Solution of APS/TMOS in a 10:90 Weight Ratio, 10 wt. % in Toluene

The procedure of Example 9 was repeated, except that in place of the primer of PE-1, the following primer solution was prepared: A 0.1 g sample of APS was added to 9 g of toluene, followed by 0.9 g of TMOS and the solution was vortexed. The resulting primer solution was wiped onto the prepared panel of PEKK substrate and heated at 60° C. for 10 minutes prior to lamination onto the adhesive side of the PVDF film. The 180° Peel Adhesion value was obtained, as summarized in Table 8, noting transfer of PSA to the PEKK substrate.

### Example 14 (EX-14): Using a Primer Solution of APS/TEOS in a 10:90 Weight Ratio, 5 wt. % in Methanol

The procedure of Example 9 was repeated, except that in place of the primer of PE-1, the following primer solution was prepared: A 0.05 g sample of APS was mixed with 9.5 g of MeOH, followed by 0.45 g of TEOS. After mixing well, 1 drop of deionized water was added to the solutions and the solutions were stirred continuously before use. The resulting primer solution was wiped onto the prepared panel of PEKK substrate and heated at 60° C. for 10 minutes prior to lamination onto the adhesive side of the PVDF film. The 180° Peel Adhesion value was obtained, as summarized in Table 8, noting transfer of PSA to the PEKK substrate.

### Example 15 (EX-15): Using a Primer Solution of NCS/ES in a 95:5 Weight Ratio, 5 wt. % in Methanol

The procedure of Example 9 was repeated, except that in place of the primer of PE-1, the following primer solution was prepared: A 95:5 weight ratio of colloidal silica (Nissan IPA-ST-UP, 16.5%) and epoxy silane (ES) were first diluted to 5 wt. % in toluene from stock and then were mixed and vortexed. The resulting primer solution was wiped onto the prepared panel of PEKK substrate and heated at 60° C. for 10 minutes prior to lamination onto the adhesive side of the PVDF film. The 180° Peel Adhesion value was obtained, as summarized in Table 8, noting transfer of PSA to the PEKK substrate.

### Example 16 (EX-16): Using a Primer Solution of NCS/ES, with Added Aluminum Ethylacetate

The procedure of Example 9 was repeated, except that in place of the primer of PE-1, the following primer solution was prepared: Colloidal silica (Nissan IPA-ST-UP, 16.5 wt. % in isopropyl alcohol) and 3-glycidoxypropyl trimethoxysilane (from Alfa Aesar, Ward Hill, Pa.) were first diluted to 5 wt. % in toluene from stock and then were mixed and vortexed. A 5 g sample of this solution was retrieved, to which 0.56 g of 5 wt. % Aluminum ethylacetate (AlEA) was added and mixed well. The resulting primer solution was wiped onto the prepared panel of PEKK substrate and heated at 60° C. for 10 minutes prior to lamination onto the adhesive side of the PVDF film. The 180° Peel Adhesion value was obtained, as summarized in Table 8, noting transfer of PSA to the PEKK substrate.

TABLE 8

| | 180° Peel Adhesion |
|---|---|
| Sample | Strength, lbs/in (N/25 mm) |
| EX-13 | <3 lb/in (<13 N/25 mm), |
| | 5-10% PSA transferred |
| EX-14 | <3 lb/in (<13 N/25 mm), |
| | 5-10% PSA transferred |
| EX-15 | 3 lb/in (13 N/25 mm), |
| | 5-10% PSA transferred |
| EX-16 | 3 lb/in (13 N/25 mm), |
| | 5-10% PSA transferred |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A multilayered article comprising:
a substrate comprising polyetherketoneketone;
an adhesion promoter disposed on the substrate, the adhesion promoter comprising at least one of organotitanate, polyamide, surface-treated nanosilica, aminosilane, or epoxy silane; and
an adhesive bonded to the adhesion promoter, the adhesive comprising at least one of an acrylic polymer, a polysulfide, a polythioether, an epoxy resin, or a silicone resin.

2. The multilayered article of claim 1, wherein the adhesive is a thermoset adhesive.

3. The multilayered article of claim 1, wherein the adhesion promoter comprises organotitanate and the adhesive comprises a polysulfide or polythioether.

4. The multilayered article of claim 1, wherein the adhesion promoter comprises epoxy silane and the adhesive comprises an epoxy resin.

5. The multilayered article of claim 1, wherein the adhesive is a pressure-sensitive adhesive.

6. The multilayered article of claim 1, wherein the adhesion promoter comprises polyamide and the adhesive comprises an acrylic polymer.

7. The multilayered article of claim 1, wherein the adhesion promoter comprises surface-treated nanosilica and the adhesive comprises a silicone resin.

8. The multilayered article of claim 1, wherein the adhesion promoter comprises aminosilane and the adhesive comprises a silicone resin.

9. A method of enhancing bond strength of an adhesive to a polyetherketoneketone-containing substrate, the method comprising:
disposing an adhesion promoter on the polyetherketoneketone-containing substrate, the adhesion promoter comprising at least one of organotitanate, polyamide, surface-treated nanosilica, aminosilane, or epoxy silane.

10. The method of claim 9, wherein the adhesion promoter comprises organotitanate and the adhesive comprises a polysulfide or polythioether.

11. The method of claim 9, wherein the adhesion promoter comprises epoxy silane and the adhesive comprises an epoxy resin.

12. The method of claim 9, wherein the adhesion promoter comprises polyamide and the adhesive comprises an acrylic polymer.

13. The method of claim 9, wherein the adhesion promoter comprises surface-treated nanosilica and the adhesive comprises a silicone resin.

14. The method of claim 9, wherein the adhesion promoter comprises aminosilane and the adhesive comprises a silicone resin.

15. The method of claim 9, wherein disposing an adhesion promoter onto the polyetherketoneketone-containing substrate comprises solution casting the adhesion promoter onto the polyetherketoneketone-containing substrate.

16. A method of making a lightning strike film comprising:
embedding an electrical conductor in a layer of adhesive;
enhancing bond strength of the adhesive to a polyetherketoneketone-containing substrate according to the method of claim 9; and
bonding the layer of adhesive to the polyetherketoneketone-containing substrate to obtain the lightning strike film.
